(19) United States
(12) Patent Application Publication
(10) Pub. No.: US 2005/0052679 A1
(43) Pub. Date: Mar. 10, 2005

(54) Method and device for controlling printing

(76) Inventors: Brett Green, Meridian, ID (US); Daniel Travis Lay, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/657,332

(22) Filed: Sep. 8, 2003

(51) Int. Cl. G06F 15/00

(52) U.S. Cl. 358/1.14

(57) ABSTRACT

In one embodiment, a method for controlling printing of print jobs in a printing device where the print jobs are received in a print queue for sequential printing comprises interrupting printing of the current print job at a boundary location in response to a first signal received at the printing device. An indicator for the interrupted print job is stored. Identifiers of the print jobs in the print queue are stored in a memory of the printing device. Another of the print jobs residing in the print queue then is selected based on selection of a corresponding one of the identifiers and a printing operation is performed on the selected print job.

### FIELD OF THE INVENTION

The invention relates to printing techniques and devices, and more particularly concerns controlling the priority of print jobs.

### BACKGROUND

In a computer network environment, network users often share the same printing resources. If two or more network users are attempting to use the same printing device at the same time, unwanted delays can occur in the printing of higher priority print jobs. For example, a large low-priority print job can seriously hold up several smaller print jobs that were initiated later but may be more important and needed sooner than the large job. This essentially allows one user or print job to disrupt or retard the work flow of several others, and can have a considerable impact on network productivity. Even relatively small print jobs placed in the print queue of a printing device can cause delays and productivity loss, because it is not possible to anticipate changes in job and/or user priorities. The problem is not limited to networked environments with plural users, because even a dedicated printing device still prints jobs according to the sequence of those jobs in its print queue. After sending a print job that will occupy the printer for a time, the user may have the need arise to process a higher priority job.

Some computer printers, copiers, facsimile machines and the like (all being examples of printers or printing devices as referred to herein) have the capability of canceling existing print jobs simply by pressing a function key on the printer or peripheral device coupled to the printer. This “cancel print job” function may cause the device to continue to read data from the active input/output (I/O) connection up until the next job boundary is reached, but to discard the data read up to that job boundary. Canceling existing print jobs in the printer enables the printer more quickly to proceed to printing the next job, as compared to waiting for the previous job to finish printing. But canceling jobs has various adverse effects such as waste of time and paper or other media, risk of inadvertent failure to attend to reprinting the canceled job later, etc. Users may have a limited capability to prioritize print jobs before they are sent to the printer, e.g., by canceling and re-sending jobs that are waiting in a Windows queue or similar software buffer to become active print jobs. However, once the print server receives a print job into its print queue, the print jobs are printed according to their position in the queue, and there is no opportunity or capability to prioritize jobs, except by canceling jobs in progress.

In certain instances, it may be desirable to enable a user to merely delay printing of a particular print job residing in a print server's print queue and allow a higher priority job to be printed first. An improved mechanism for controlling the priority of print jobs is desired.

### SUMMARY

According to an aspect of the invention, a method for controlling printing of print jobs in a printing device where the print jobs are received in a print queue for sequential printing comprises interrupting printing of a current print job upon reaching a boundary location in response to a first signal received at the printing device. An indicator for the interrupted print job is stored. Another of the print jobs residing in the print queue is selected from a memory containing identifiers of the print jobs in the print queue, and a printing operation is performed on the selected print job. In response to a second signal received at the printing device, printing of the previously interrupted print job is resumed according to the stored indicator.

According to another aspect, a printing device for carrying out print jobs comprises a print queue for storing print jobs fed to the printing device. A user interface enables selecting one of a first mode of operation and a second mode of operation. A processor responsive to selection of the second mode of operation determines a boundary location associated with a current print job while being printed and operates to interrupt and suspend further printing of the current print job upon reaching the boundary location. Storage circuitry is configured for storing an indicator of the boundary location of the interrupted print job. The processor then causes the print jobs in the print queue to be stored in a memory location accessible using the user interface. A control on the user interface enables selection and initiation or resumption of printing of another one of the print jobs in the print queue. In response to de-selection of the second mode of operation at the user interface, the processor can be configured to proceed to resume printing of the interrupted print job according to the indicator.

### BRIEF DESCRIPTION OF THE DRAWING

FIG. 1 is an illustration of an image forming system.

FIG. 2 is a block diagram illustrating major components of an image forming system including a printing device and host device according to an embodiment of the present invention.

FIG. 3 is an exemplary illustration of a control panel formed on a printing device for use in connection with controlling printing according to an aspect of the invention.

FIG. 4 is a flow chart depicting an exemplary methodology executable within the printing device according to an aspect of the invention.

FIG. 5 is a simplified block diagram illustrating major components of an image forming system including a printing device and host device according to another embodiment of the invention.

FIG. 6 is an exemplary illustration of a control panel provided at a peripheral device for controlling printing according to an aspect of the invention.

### DESCRIPTION

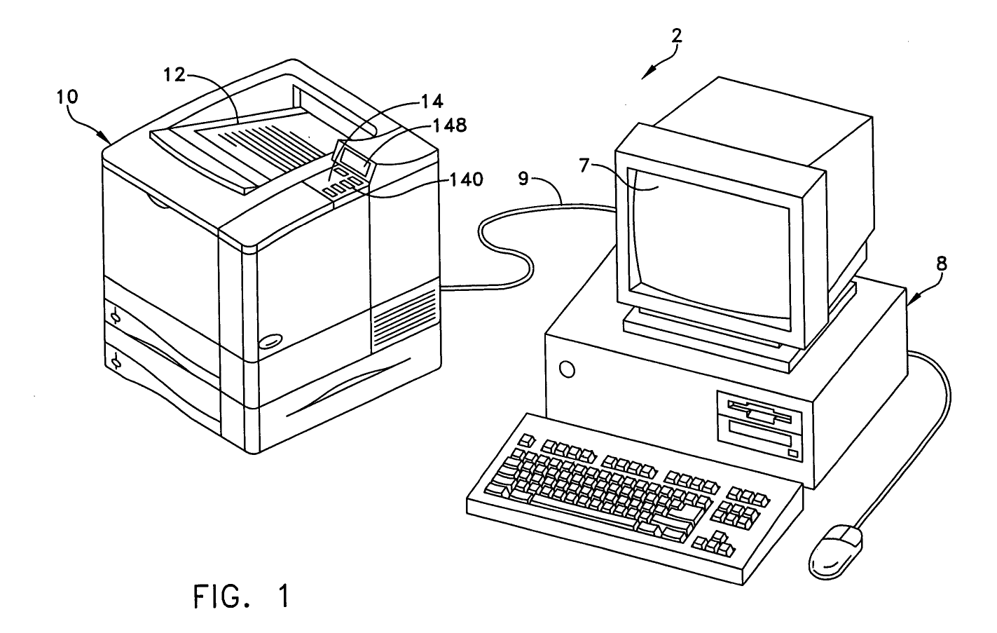

FIG. 1 shows an exemplary embodiment of an image forming system 2 comprising a host device 8 and a printing device 10, coupled to the host device 8 via communication medium 9. Host device 8 may be implemented as a personal computer (PC), server, Web server, or other device configured to communicate with printing device 10. In this embodiment, host device 8 includes a display 7 such as a CRT or flat panel monitor, and a keyboard and mouse, for exchange of information with a human user. An exemplary communication medium 9 could include a connection direct to host device 8 such as a wired parallel or serial port, a USB connection, an infrared or wireless connection, a packet switched network connection such as a LAN or Intranet network (e.g., Ethernet arrangement), and/or WAN or Internet connection, or another communication configuration operable to provide electronic exchange of information between a host device 8 and printing device 10, using an appropriate protocol at least for passing print data to the printing device 10 and preferably also status information to the host device 8. The invention is also applicable to other image forming systems and arrangements, e.g., including one or more host devices 8 and/or additional printing devices 10, coupled at least at pertinent times over a data path represented generally by communication medium 9.

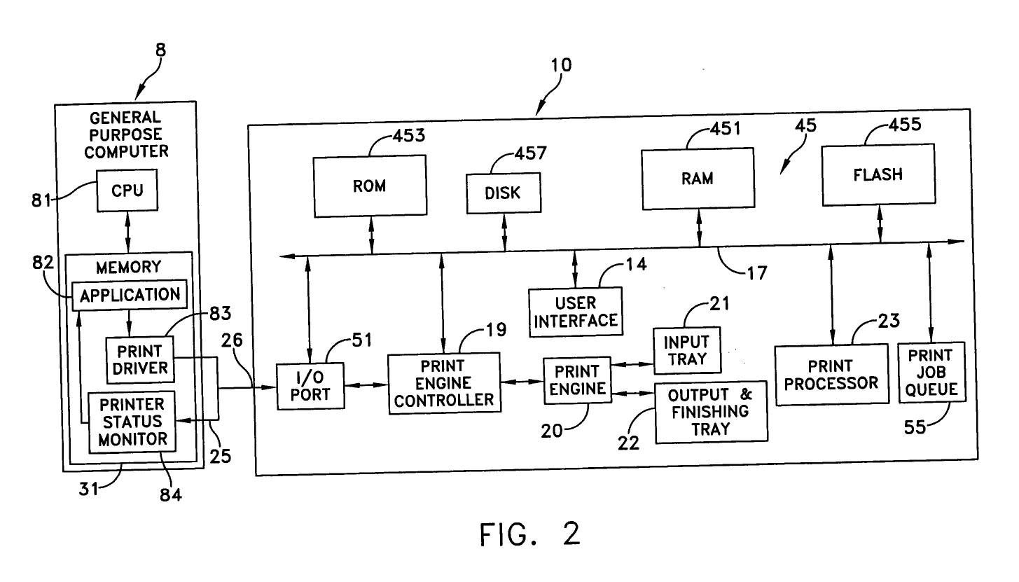

Printing device 10 is configured to fix images on print media 12. The images are not limited as to content and could include, for example, one or more of characters, iconic symbols, lines, colors, shading, pictures, patterns, drawings and other forms of information, decoration and graphic depiction. Typical forms of media 12 comprise paper, envelopes, transparencies, labels or other material. The printing device 10 may be embodied as a laser printer, ink jet printer, dot matrix impact or thermal printer, dry medium printer, multiple function peripheral device, photocopier, facsimile machine, plotter, combination device or other arrangement configured to form images on media 12. FIG. 2 is a block diagram illustrating major components of printing device 10, as configured to print and to control the priority of print jobs according to an embodiment of the present invention. Printing device 10 includes an input/output (I/O) interface 51, print processor 23, print engine controller 19 coupled to print engine 20, and memory 45. These elements are coupled for data communication, for example over a shared bus 17. In one configuration, I/O interface 51 is a serial interface, such as a universal serial bus (USB) interface. In another configuration, I/O interface 51 is a network interface, such as an IEEE-1394 interface. In other configurations, other types of interfaces may be used, including those for wireless communications, for example. The I/O interface enables communication with host device 8 to convey information necessary to enable the printing device to print the desired output, such as character information, rasterized information, and/or page description language provided from or through host device 8 and to be processed by the printing device 10, and typically also at least some reporting of status information from the printing device to the host.

Aspects of the invention are applicable to embodiment as a method or apparatus. Furthermore, the steps that the processor and the printing device as a whole undertake in coordination with one another are determined and managed according to the programming of the associated processor(s) as well as according to the data to be printed. The programming that controls operation likewise can be contained in the printing device or distributed and made available to the processor that employs it. In this respect, the printing device and its processors can be responsive to programming stored in a data carrier such as a semiconductor memory or on disk or CD or downloaded to a memory (e.g. volatile memory) from another source. The programming instructions that actually are executed by the processor can be complete as supplied, or can be generated as the output of another process associated with the printing device or associated processor, for example. They can exist as software program(s) comprised of program instructions in source code or object code, executable code or other formats, and can include hardware, firmware and combinations thereof. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Examples of the foregoing include distribution of the program(s) on a CD ROM or via Internet download. The same is true of computer networks in general.

Referring to the embodiment shown in block form in FIG. 2, memory 45 may include multiple types of memory, including both volatile and non-volatile memory, such as random access memory (RAM) 451, read-only memory (ROM) 453, and flash memory 455, for example. Memory may also include a hard disk 457 for storing various printer related information, including print job page boundary information, print job identifiers, and imaging and text information, for example. Memory 45 may store file system information, printing device identifier characteristics (e.g., printing device serial number) and firmware. Printer macros may also be stored in file system memory, and made available for use by a print application in a host device coupled to the printing device 10. A print job queue 55 spools the print jobs sent to the printing device for sequential printing. The print job queue 55 operates as a buffer that is loaded as jobs are received from host 8 or are generated as a result of communications with host 8, typically substantially faster than the jobs can be printed. The print job queue 55 likewise empties as jobs are completed by printing device 10. The queue 55 is a first-in-first-out accumulating buffer. According to an aspect of the present invention, the printing device 10 enables variation from that order of printing so that the user can change the order of printing after the print data has moved from host 8 to printing device 10.

Additional hardware of the depicted printing device 10 includes input tray(s) 21 and output and finishing tray(s) 22. Print processor 23, for example comprising a microprocessor or CPU, is configured to manage functions of the printing device 10 in coordination with print controller 19. The print engine controller 19 and associated print engine 20 are coupled to bus 17 and provide print output capability for the printing device 10.

During printing of a current print job from print queue 55 of device 10, sheet media is extracted from input tray 21, operated upon by print engine 20, and directed to output and finishing tray 22. Page boundary information, including start and end boundary locations for each page of a print job stored in the print queue, is maintained in memory to enable operation of the print process on a page basis. The boundary location can be the occurrence of a page feed in a multi-page print job, a line boundary or line feed, or otherwise as appropriate to the type of print job. Boundary location information defining line and page boundaries enables printing to proceed more or less continuously up to a point at a perimeter of the print medium, such as at a predetermined margin. Printing pauses as a new sheet is loaded or as a print carriage is reversed or repositioned (not shown). Printing then proceeds toward the next boundary.

Output and finishing tray 22 includes, in an exemplary embodiment, finishing feature mechanisms such as abutments that may be movable to ensure sheet registration, devices for binding, stapling, punching, and the like, and possibly also separate cubby holes, shelves or bins for collation or “mailbox” sorting purposes. Input tray 21 may also include a plurality of input trays enabling selection among choices of print media such as different paper sizes or orientations.

As shown in FIG. 2, host device 8 may comprise a general purpose computer including a processor 81 capable of executing at least one program, such as an application program 82. The computer also includes a print driver 83 which interfaces between the application program 82 (or underlying operating system) and the printing device 10. The driver 83 receives commands from the application program 82 (or operating system) and where necessary formats or translates them into commands that the printing device 10 is configured to execute appropriately by virtue of its hardware and possibly programming. The host device 8 also runs a printer status monitor program 84, which displays the status of printing device 10. The printer status monitor 84 receives information from the printing device 10 identifying conditions such as “tray open,” “paper jam” or “out of paper,” and displays the printer status information on the monitor of the host device 8. In one configuration, the printer status monitor 84 also is responsive to receipt of a message 25 to recognize a condition in which the controls on the printing device are activated.

Print operation requests are sent from host device 8 to printing device 10 via print driver 83 to request execution of a print job. The print signal 26 coupled from print driver 83 includes identification information for executing printing operations by device 10, including, for example, content information and an identifier for the requested print job. The identifier may include for example, one or more of the user name requesting the print job, the host device location or identifier, a unique job ID that may contain a sequence number or time stamp, and the like. The identifier enables the requested job to be distinguished from other jobs resident in the print queue.

The print signal 26 can contain data that controls printing parameters, or data that is used by the printing device 10 to generate controls based on the data, or both. Control and parameter data that can be provided to printing device 10 can include general information concerning the print job, a data file of character contents to be printed (e.g. text character data, graphics, etc.) and/or commands in a page description language (PDL). The print data is communicated to print processor 23 of printing device 10 via I/O interface 51 for initiating and executing the printing operation. The print job requested to be printed on printing device 10 is stored in print queue 55 for printing. The print queue 55 comprises a spool or memory buffer for storing printing jobs to be printed in the sequential order that the jobs are received and loaded into the queue.

According to an aspect of the invention, printing device 10 includes a printer user interface 14 configured on a control panel or similar device to display status information of the printing device 10 and to enable certain user selections. The printer user interface 14 as shown in FIG. 1 has a control input 140 such as a switch keypad and a display screen 148. The printer user interface 14 is operable to receive input selections from a user to control operation of the printing device 10. User interface 14 can comprise any one or combination of menus, display screens, lamps or LEDs, audible signal generators, touchpads, keyboards, keypads, buttons, help screens, tactile input devices, selectors and pointers such as a mouse, and other input hardware/software techniques.

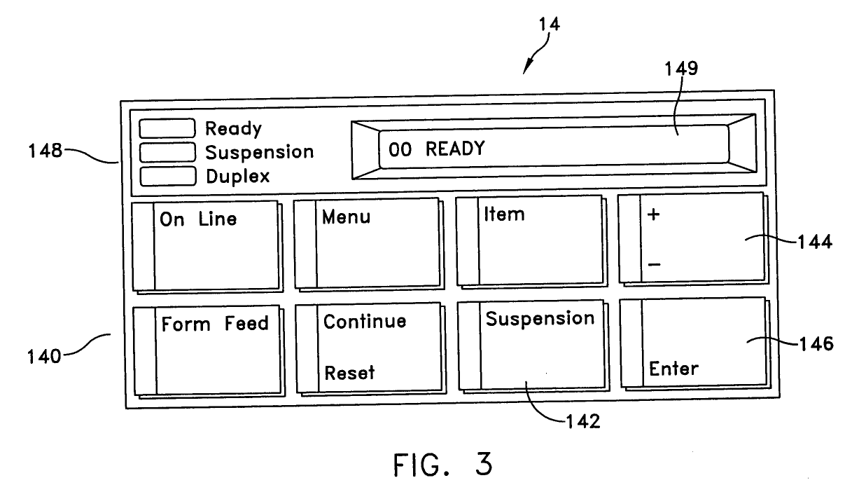

FIG. 3 is an exemplary illustration of a user interface control panel 14 provided on printing device 10 for controlling printing according to an aspect of the invention. Interface 14 includes a suspend or interrupt button 142 configured to generate a request to the print processor that enables the user to change the order of printing jobs from the print queue, including the capability to interrupt printing of the print job currently in progress of printing from the print queue. The printing device is configured to spool or otherwise buffer the print jobs in the print queue to a memory location for access by a user.

Scroll button 144 enables a user to show and selectively to scroll through and to select among queued print jobs whose identifications are at least partly displayed in display window 149. The user can scroll from one print job to a next print job without discarding from the queue the jobs that are passed over during such scrolling and selection.

Selection of a given print job from the display window 149 for immediate printing is accomplished by depressing selection button 146, which transmits a request to print the selected print job immediately. The print processor is configured to execute operations to retrieve from memory parameter information associated with the selected print job, including the start and end job boundary locations, image data, and the like, and to execute the print operation so that the selected job is printed out of order from its original sequential position in the print queue. When the desired print job(s) for priority printing are completed, toggling button 142 causes a request to be transmitted to the print processor to exit this mode of operation and to resume sequential printing of the print jobs from the print queue. In another configuration, the interrupted job can automatically resume after the immediately printed priority job or after a given time period where no operator input has occurred. These alternatives can be made as programmed fixed arrangements or as default processes that the user can override by making setup selections, or as selections that the user makes whenever interrupting a job in progress.

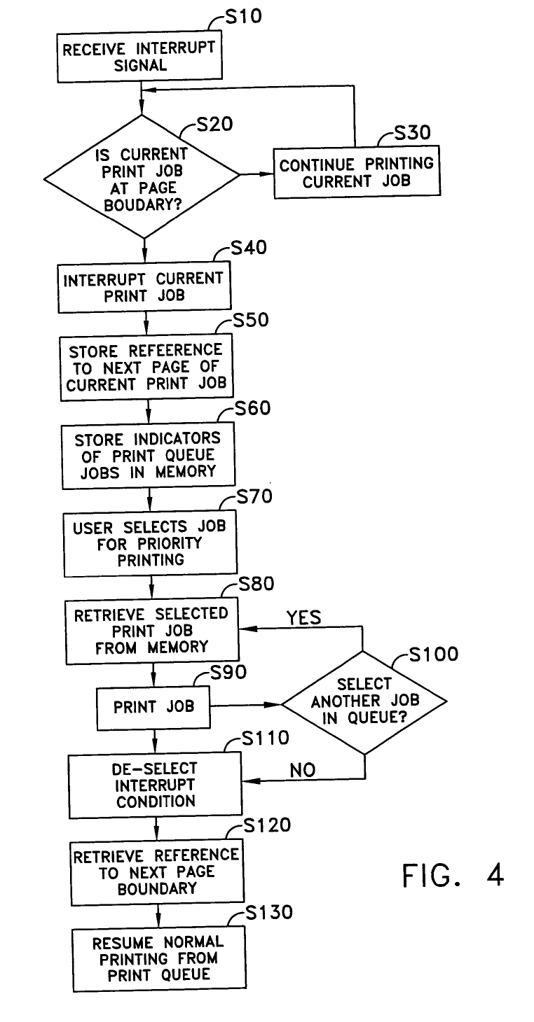

Referring to FIG. 4, an exemplary methodology for controlling printing priorities within printing device 10 is shown according to an aspect of the present invention. The depicted methodology is implemented as a series of ordered executable instructions stored within the printing device 10 for execution via processor 23 and associated control circuitry, that may be implemented in software, hardware, firmware and/or combinations thereof.

In an exemplary operation of printing device 10, an operator is allowed to selectively control the priority of print jobs in the print queue in the event that a given job is deemed to require higher priority within the printing device by operating a control 142 on the front menu panel of printing device 10 (see FIG. 3). Control 142 generates a signal to the printing device to suspend or interrupt sequential printing operations from the print queue of the printing device 10.

As shown in the example of FIG. 4, The interrupt signal is received by the print processor at step S10. The print processor checks the print queue for the current print job and determines whether the current print job is at a page boundary location (step S20). The print processor accesses memory locations associated with the track set or page boundary of each page of the print job to be printed to determine the next boundary location. If the print job is not at a page boundary (step S20), printing continues and the sequence loops (steps S20-S30) until the current print job reaches the next page boundary (step S30). At that point, execution of the current print job is immediately interrupted (step S40). The print processor stores in a memory location (e.g. memory 45, identified in FIG. 2) an indicator of the print job being interrupted and the next page boundary location associated with that print job (step S50). The indicator may include a datum that otherwise enables the boundary location to be found.

The print jobs that are in the print queue 55 (see FIG. 2) and awaiting printing are spooled or otherwise provided to a memory location, such as a hard disk file (step S 60) accessible to an operator via the user interface on the control panel of the printing device. Appropriate distinguishing identifiers (e.g. print job ID, user ID, etc.) associated with each print job residing in print queue 55 are displayed to the operator at the control panel by default or when selected. The operator can scroll through the identifiers in the list of print jobs, and select one of the jobs for immediate printing (step S70). The print job selected by the operator is retrieved (step S80) and a print operation is executed, thereby immediately printing the selected print job at printing device 10 (step S90).

Upon completion of the print operation, the processor waits for additional input from the operator to either select another print job from the displayable list for printing (step S100), or to de-select the print interrupt condition (step S110). The operator optionally can be prompted, e.g., by an audible signal. De-selection can occur automatically in lieu of operator input, for example, upon lapse of a predetermined delay time. Upon de-selection of the print interrupt condition at the control panel of the printing device (step S110), or upon selection by the operator of the interrupted print job, the page boundary location reference associated with the interrupted print job is retrieved from memory (step S120). Printing of the interrupted print job is resumed at the page location boundary (step S130), i.e., normally at the beginning of the sheet following the last completed sheet of the job. Upon completion of the previously interrupted print job, the remaining print jobs in the print queue can be printed in regular sequential order.

In one configuration, the printing device may include means for enabling only authorized users to suspend a print operation from the print queue and to adjust the order of printing already-queued jobs to control print job priorities. This may be accomplished, for example, by requiring a user to enter an authorization code such as a PIN in response to a request to suspend print operations, and/or a request to select another print job for priority printing. Such authorizations can be logged and made available for display.

In another embodiment, operator control of the order or priority of print jobs waiting in the print queue can be displayed and adjusted at least partly by using a control panel display associated with host device 8. This allows job monitoring and priority adjustment (namely job suspensions while printing and changes in the printing order of jobs in the print queue) without requiring operator presence in the immediate vicinity of the printing device, as otherwise necessary to perform control operations on the printing device console. This embodiment is also useful in connection with certain printing devices that may not include a local operator control and display panel or console for performing priority print control by means of indicators and switches mounted on the printing device itself.

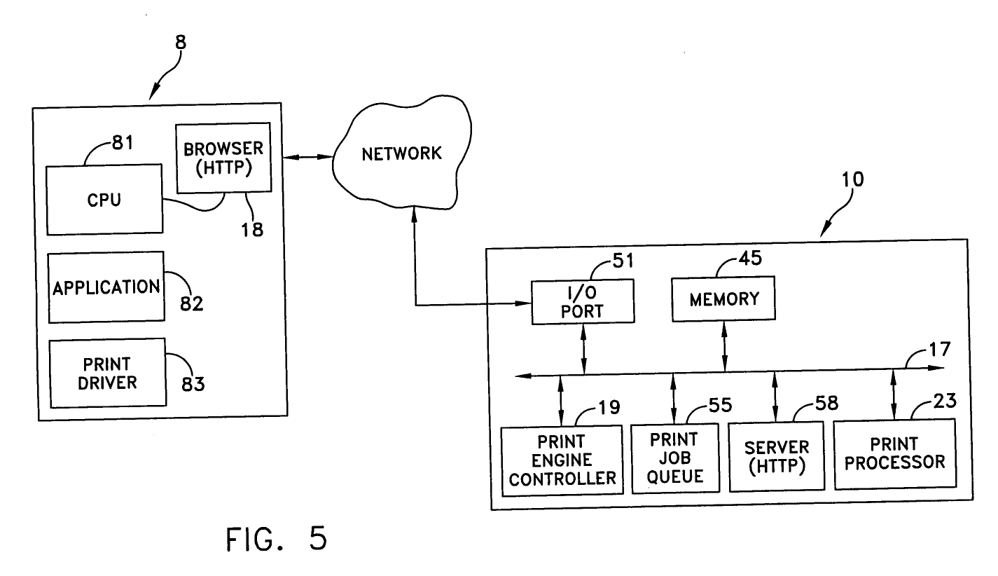

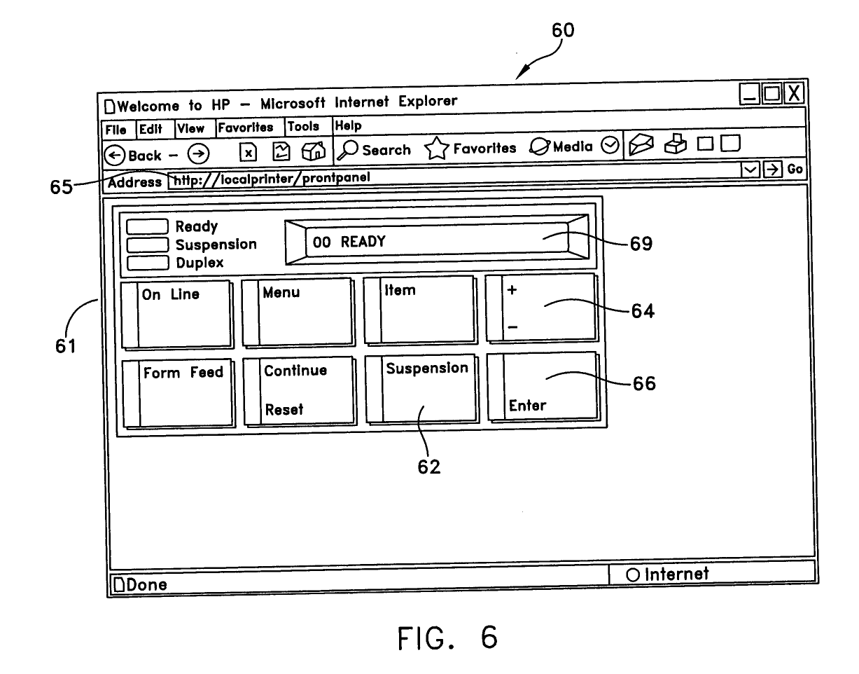

FIG. 5 illustrates a simplified architecture of printing device 10 and host device 8 embodying these aspects. In one configuration, printing device 10 includes a web server 58 for communicating with a web browser 18 of host device 8 to control print job priorities. Web server 58 maintains web pages including a “home page” 60 shown in FIG. 6. The home page is populated with data that reflects information otherwise provided on a printing device console, such as the contents and order of the print queue, and permits the user to make selections using the keyboard or mouse of host device 8. Referring to FIG. 6, an exemplary presentation of a display panel 61 is transmitted by web server 58 (see FIG. 5) to host device 8 that has a browser application that has addressed a request to the printing device 10. The printing device 10 can have a hypertext internet protocol (IP) address or URL 65 associated with the control panel function of device 10 and can communicate using TCP packet data communication protocols.

Addressing a request via web browser 18 of host device 8 to the address 65 of printing device 10 causes the printing device to return data representing the current state of the print queue, entered in the home page virtual display panel 60. Virtual buttons such as buttons 62, 64, 66 provide a linking to other pages and cause the printing device to respond according to the control operations initiated by the operator at the host device. Additional functions such as drag-and-drop lines and icons can be served.

In accordance with the architecture depicted in FIG. 5, an exemplary operation is commenced by transmitting a request via web browser 18 of a host device 8 to web server 58 of printing device 10 over a communication network, such as the Internet. In one configuration, a proxy agent may be installed on the host device for communication with a locally connected printing device 10. As shown in FIG. 6, the printing device responds to the request from host device 8 with display panel 60 having user selectable button 62 for suspending or interrupting printing operations in the print queue of the printing device. Selection of button 62 causes a signal to be received at web server 58, which communicates with print processor 23 to cause the print processor to execute the operations depicted in FIG. 3. Operator control and selection of print jobs may be accomplished by manipulation of scroll button 64 to cause print job identifiers to scroll in display window 69. Selection of a given one of the print jobs for priority printing may be accomplished by selection of button 66 for transfer to the printing device. Toggling “off” suspension button 62 (i.e., de-selection of the interrupt function) releases the printing device to resume printing of the previously interrupted print job and to proceed to any remaining print jobs in their original order of receipt. In this configuration, user control of the print queue is enabled at the host device rather than at the printing device itself.

While aspects of the present invention have been described in the context of an image forming system, those of ordinary skill in the art will appreciate that the processes according to the invention are capable of being embodied and distributed in the form of a computer readable medium of instructions in a variety of forms. The invention applies equally to such forms, regardless of the particular type of signal bearing media actually used to carry out the distribution and regardless of the nature of the programming instructions, factors or other specific programming techniques. Examples of computer readable media include recordable-type media, such as a floppy disk, hard disk drive, RAM, ROM, CD-ROM, DVD-ROM, and transmission-type media, such as digital and analog communications links, wired or wireless communications links using transmission forms, such as, for example, radio frequency and light wave transmissions. The computer readable media may take the form of coded formats that are executable as well as formats that are interpreted or decoded for actual use in a particular data processing system.

Although the invention has been described and pictured in exemplary forms with a certain degree of particularity, it is understood that the present disclosure of such forms is made by way of example, and that numerous changes in the details of construction and combination and arrangement of parts may be made without departing from the spirit and scope of the invention as hereinafter claimed. It is intended that the patent shall cover by suitable expression in the appended claims, whatever features of patentable novelty exist in the invention disclosed.

1. A method for controlling printing of print jobs in a printing device, said print jobs residing in a print queue for sequential printing, comprising:
in response to a first signal received at said printing device, interrupting printing of a current print job in said print queue upon reaching a boundary location;
storing an indicator associated with said interrupted print job;
storing identifiers of said print jobs in said print queue in a memory of the printing device;
selecting from said memory at least one of said identifiers corresponding to another print job and printing said selected print job; and
in response to a second signal, resuming printing of the previously interrupted print job according to said indicator.

2. The method of claim 1, wherein said storing an indicator associated with said interrupted print job comprises storing an indicator of the boundary location at which the current print job was interrupted.

3. The method of claim 2, wherein printing of said interrupted print job is resumed at said boundary location.

4. The method of claim 3, wherein said boundary location is a page boundary.

5. The method of claim 1, wherein at least one of said first signal and said second signal is caused by a user operating a control on the printing device.

6. The method of claim 1, wherein at least one of said first signal and said second signal is caused by a user operating a control on a peripheral device in operable communication with said printing device.

7. The method of claim 6, wherein said peripheral device is a host computer having a web browser in operable communication with a web server in said printing device over a communication network, to provide user control for generating at least one of said first signal and said second signal.

8. The method of claim 1, further comprising verifying an authorization of a user requesting interruption of the current print job prior to said interruption of printing.

9. The method of claim 1, wherein said storing identifiers of said print jobs in said print queue in a memory of the printing device comprises storing one or more of: user name requesting said print job, host device, and print job name.

10. A printing device for carrying out print jobs, comprising:
storage means for storing print jobs in the printing device for sequential printing;
means for selecting one of a first mode of operation and a second mode of operation of said printing device;
means responsive to selection of said second mode of operation for determining a boundary location associated with a current print job for printing and for interrupting printing of said current print job upon reaching said boundary location;
means for storing an indicator of said boundary location associated with said interrupted print job;
means for selecting and printing another one of the print jobs in said storage means; and
means responsive to de-selection of said second mode of operation for resuming printing of the interrupted print job according to said indicator.

11. The device of claim 10, wherein said boundary location is a page boundary.

12. The device of claim 10, wherein said means for selecting one of said first mode of operation and second mode of operation comprises a user-operated control disposed on said printing device.

13. The device of claim 10, wherein said means for selecting one of said first mode of operation and second mode of operation comprises a user-operated control disposed remote from said printing device and in operable communication with said printing device over a communications network.

14. The device of claim 13, wherein said user-operated control comprises one or more user selectable options on a display of a host computer having a web browser in operable communication with a web server of said printing device to provide said user control.

15. The device of claim 10, further comprising means for verifying an authorization of a user requesting interruption of the current print job prior to said interruption of printing.

16. A method for controlling printing of print jobs in a printing device, said print jobs residing in a print queue for sequential printing, comprising:
sensing a request from a user to interrupt printing of a current print job;
determining a page boundary location associated with the current print job being printed and interrupting printing of the current print job upon reaching the page boundary;
storing an indicator of the page boundary at which the current print job was interrupted;
storing an identifier of each print job in said print queue in a memory of the printing device;
retrieving a user-selected identifier from said memory corresponding to another one of the print jobs in said print queue and printing said another print job;
sensing a request from a user to resume printing of said interrupted print job; and
retrieving said indicator of said page boundary and resuming printing of the previously interrupted print job at the page boundary at which the job was interrupted, whereby upon completion of printing said previously interrupted print job, remaining print jobs residing in said print queue are printed in sequential order.

17. The method of claim 16, further comprising providing a user-operated control on the printing device for causing a request to be transmitted to interrupt printing of a current print job.

18. The method of claim 16, further comprising providing a user-operated control on a host device coupled to the printing device for causing a request to be transmitted from the host device to interrupt printing of a current print job.

19. A computer readable medium encoded with computer-executable instructions for controlling operation of a processor of a printing device to cause the processor to perform a method comprising:
in response to a first signal received at said printing device, interrupting printing of a current print job in said print queue upon reaching a boundary location;
storing an indicator associated with said interrupted print job;
storing identifiers of said print jobs in said print queue in a memory of the printing device;
selecting from said memory at least one of said identifiers corresponding to another print job selected for printing and printing said selected print job; and
in response to a second signal, resuming printing of the previously interrupted print job according to said indicator.

20. The computer readable medium of claim 19, wherein said computer-executable instructions further control operation of said processor for determining said boundary location and storing an indicator of the boundary location at which the current print job was interrupted.

21. The computer readable medium of claim 20, wherein said computer-executable instructions further control operation of said processor for resuming printing of said interrupted print job at said boundary location.

22. The computer readable medium of claim 21, wherein said boundary location is a page boundary.

23. The computer readable medium of claim 19, wherein at least one of said first signal and said second signal is caused by a user operating a control on the printing device.

24. The computer readable medium of claim 19, wherein at least one of said first signal and said second signal is caused by a user operating a control on a peripheral device in operable communication with said printing device.

25. The computer readable medium of claim 24, wherein said peripheral device is a host computer having a web browser in operable communication with a web server in said printing device over a communication network, to provide user control for generating at least one of said first signal and said second signal.

26. The computer readable medium of claim 19, wherein said computer-executable instructions further control operation of said processor for verifying an authorization of a user requesting interruption of the current print job prior to said interruption of printing.

27. The computer readable medium of claim 19, wherein said computer-executable instructions further control operation of said processor for storing identifiers of said print jobs in said print queue in memory comprising storing one or more of user name requesting said print job, host device, and print job name.

28. A printing device for carrying out print jobs, comprising:
a print queue for storing print jobs in said printing device for sequential printing;
a user interface operable for selecting one of a first mode of operation and a second mode of operation of said printing device;
a processor responsive to user selection of said second mode of operation for determining a boundary location associated with a current print job for printing and for interrupting printing of said current print job upon reaching said boundary location;
memory for storing an indicator of said boundary location associated with said interrupted print job;
wherein said processor causes said print jobs in said print queue to be stored in a memory location accessible using the user interface for enabling user selection and initiation of printing of another one of the print jobs in the print queue, and wherein, in response to de-selection of the second mode of operation at said user interface, said processor operates to resume printing of the interrupted print job according to said indicator.

29. The device of claim 28, wherein said boundary location is a page boundary.

30. The device of claim 28, wherein said user interface comprises a user-operated control panel disposed on said printing device.

31. The device of claim 28, wherein said user interface comprises a user-operated control panel disposed remote from said printing device and in operable communication with said printing device over a communications network.

32. The device of claim 31, wherein said user-operated control panel comprises one or more user selectable options on a display of a host computer having a web browser in operable communication with a web server of said printing device to provide said user control.

33. The device of claim 28, wherein said user interface further includes a control input for enabling a user to enter a code for verifying an authorization of said user requesting interruption of the current print job prior to said interruption of printing.
